(19) United States
(12) Patent Application Publication
(10) Pub. No.: US 2004/0050573 A1
(43) Pub. Date: Mar. 18, 2004

(54) Receptacle pre-mold assembly with integral breaker

(76) Inventors: Cheng Yu Lin, Pingjen City (TW); Shih Hao Lin, Shindien City (TW)

Correspondence Address: David T. Bracken, The Law Office of David T. Bracken, 4839 Bond Avenue, Orange, CA, 92869, US

(21) Appl. No.: 10/241,861

(22) Filed: Sep. 13, 2002

(51) Int. Cl. H01H 9/02

(52) U.S. Cl. 174/53

(57) ABSTRACT

The present invention is a side to side arrangement receptacle for a cord with single receptacles spaced apart along a single main cord. The invention comprises a pre-mold piece with a circuit breaker for a single receptacle adapted to be molded into a flexible body. The invention pre-mold piece comprises a floor piece supporting two or three bars with wire engaging ends, whereby all the bars but one comprise upward mid length extensions adapted to engage plug prongs when those upward extensions are supported laterally by an upper housing. A top conductive bar extends into the breaker to connect with its circuit and another bar extends from the breaker into the piece housing to an extension adapted to engage plug prongs.

### BACKGROUND OF THE INVENTION

The present invention relates to pre-mold pieces for electrical plugs, typically of the 120 VAC type.

The prior art describes extension cords where multiple single receptacles are attached with intervening sections of cord. This allows the user to have single receptacles available along the length of the cord instead of at an end position.

U.S. Pat. No. 5,902,148 shows a series of single receptacles spaced along a length of extension cord. The invention is directed to an extension cord with three conducting wires for a typically 240 VAC connection. The alignment of a two receptacle slot is parallel to the axis of the cord so that the user must turn a cord 90 degrees from a position in which the user would typically approach that cord.

U.S. Pat. No. 5,236,374 repeats this slot alignment with respect to the cord in and out of the molded receptacle housing. FIGS. 6-8 show the reason that this alignment has been so well favored in the prior art. The particular construction of the conductive bars through the receptacle favors the less than advantageous orientation of an “up and down” orientation than a side to side orientation.

US Pat. No. D264330 also slavishly repeats the “up and down” orientation with respect to the direction of the isolated receptacle having a conductive cord extending into and out of the body of the receptacle.

Even when the design is relatively different, i.e., a rigid housing between spaced apart receptacle slots as in U.S. Pat. No. 2,952,829, the “up and down” or parallel orientation is maintained. Once again, automated manufacturing with the prior art conductive bars favor the less than advantageous construction.

One prior art reference indicates that the side to side arrangement would be more advantageous for the user, although the solution is rather expensive and difficult to implement. U.S. Pat. No. 5,234,360 shows that the very short “pigtails” extending from a main extension cord provide individual receptacles for other plugs. The orientation of the receptacle slots is shown in a side to side arrangement with respect to the main cord. However, in order to achieve this orientation a difficult to form extension must be made with wires and covering from a main cord. There is a need for a side to side arrangement receptacle for a cord with single receptacles spaced apart along a single main cord.

### SUMMARY OF THE INVENTION

The present invention is a side to side arrangement receptacle for a cord with single receptacles spaced apart along a single main cord. The invention pre-mold piece is adapted to be molded into a flexible body. The invention pre-mold piece comprises a floor piece supporting two or three bars with wire engaging ends, whereby the bars comprise upward mid length extensions adapted to engage plug prongs when those upward extensions are supported laterally by an upper housing. The upper housing is optionally of clear plastic so that an LED effectively connected with the circuit indicates if the cord of the invention is connected to a live electrical source. A breaker is integral with the pre-mold piece so that if electrical current through a single separated receptacle is above a permitted level, the breaker will open that single circuit while the other receptacles will continue to receive current.

### BRIEF DESCRIPTION OF THE DRAWINGS

FIGS. 1, 2, and 3 are respectively top, side and front views of an invention pre-mold piece showing wire engaging ends of conducting and ground wire bars.

FIG. 4 is a top view of the invention pre-mold pieces molded into 3 separated and single receptacles.

FIGS. 5 and 6 are respectively top and side views of an invention pre-mold piece molded into a separate and single receptacle body.

FIGS. 7, 8 and 9 and 8 are respectively side, top and end views of a representative side to side middle conductive bar for the invention pre-mold piece with wire engaging portions at the ends.

FIGS. 10, 11, and 12 are respectively top, side, and end views of a representative side to side top conductive bar for the invention pre-mold piece with wire engaging portions at the ends and a prong engaging extension from the breaker, each oriented as required in final assembly of the pre-mold piece.

FIG. 13 is a top view of a representative supporting base plate for the pre-mold piece with two staggered and parallel conductive bars adapted to engage a plug with no ground prong.

FIG. 14 is a top view of a representative supporting base plate for the pre-mold piece with three spaced apart and parallel conductive bars adapted to engage a plug with a ground prong.

FIG. 15 is a view into the bottom and open end of an upper housing of the pre-mold piece for the receptacle showing a representative top housing with rectangular and supportive bores for two conductive wire prongs and a semicircle and supportive bore for a ground wire prong as shown for the conducting bars for the base plate and bars shown in FIG. 14.

FIG. 16 is the complementary base plate for the upper housing of FIG. 15 with the conductive bars of FIG. 14 operatively placed in the base plate, whereto the upper housing is attached to form the invention pre-mold assembly.

### DETAILED DESCRIPTION OF THE INVENTION

The invention is now discussed with reference to the figures.

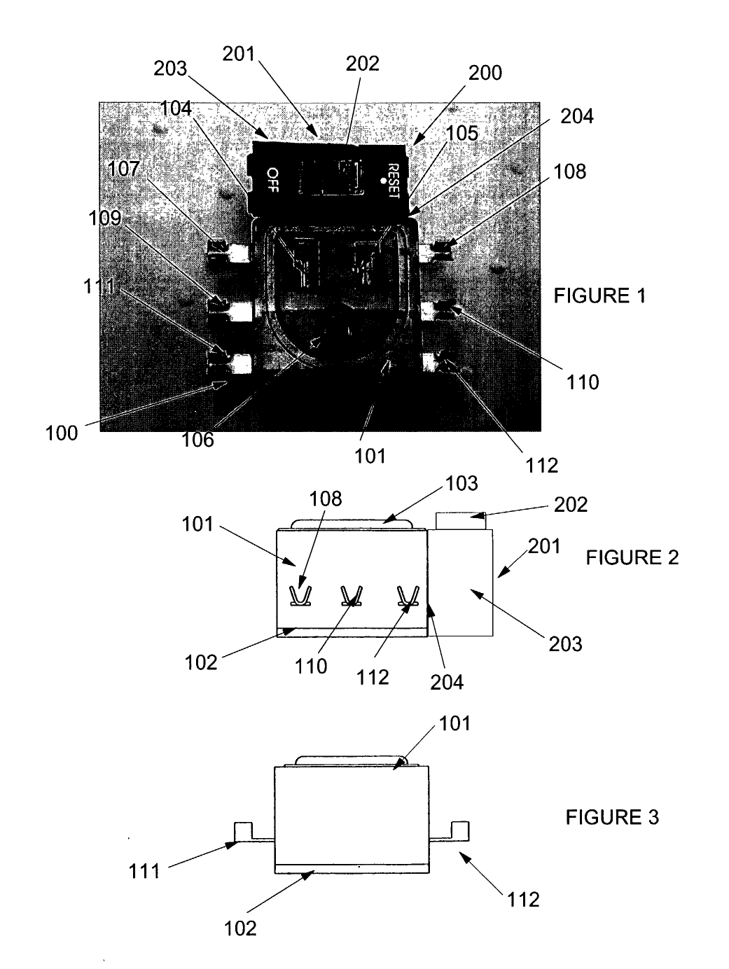

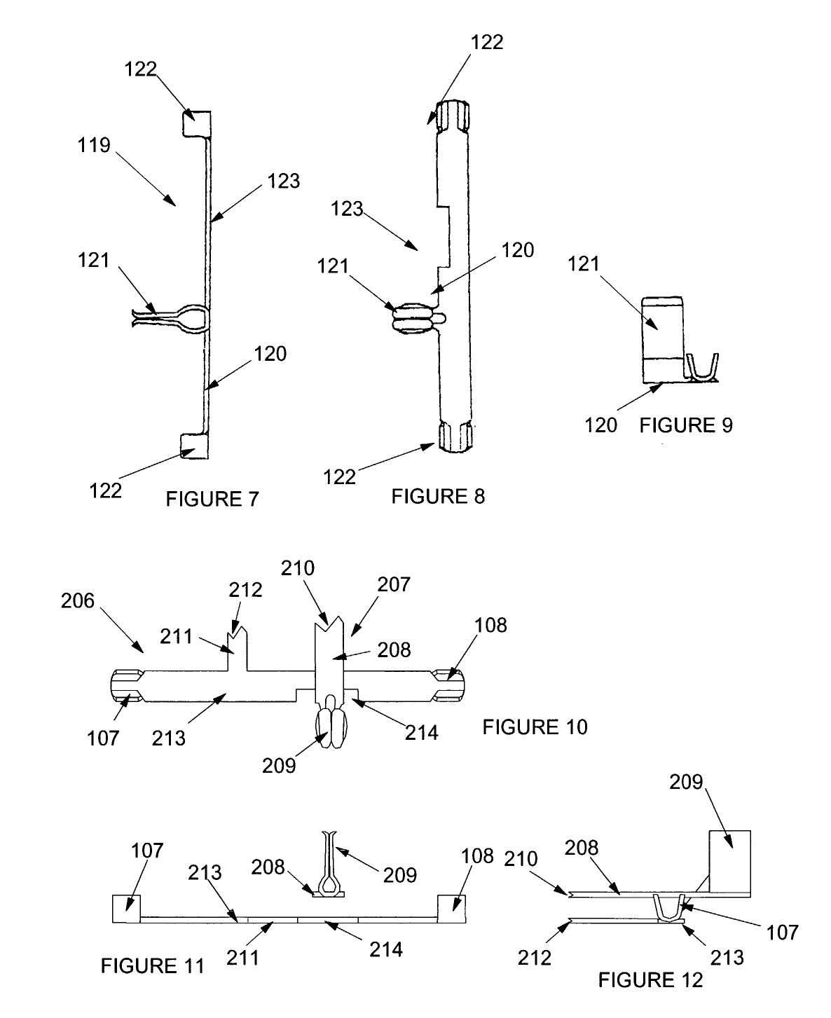

FIG. 1 shows assembly 200 comprising pre-mold piece 100 operatively connected with breaker 201 to accomplish the objects of the invention. For piece 100, upper housing 101 and base plate 102 enclose mid parts of conductive bars 206 (in FIGS. 10-12) and 126 (in FIGS. 7-9) for conductive wires with respectively wire engaging ends 107/108 and 109/110 and mid parts of ground wire conductive bar 128 with wire engaging ends 111/112.

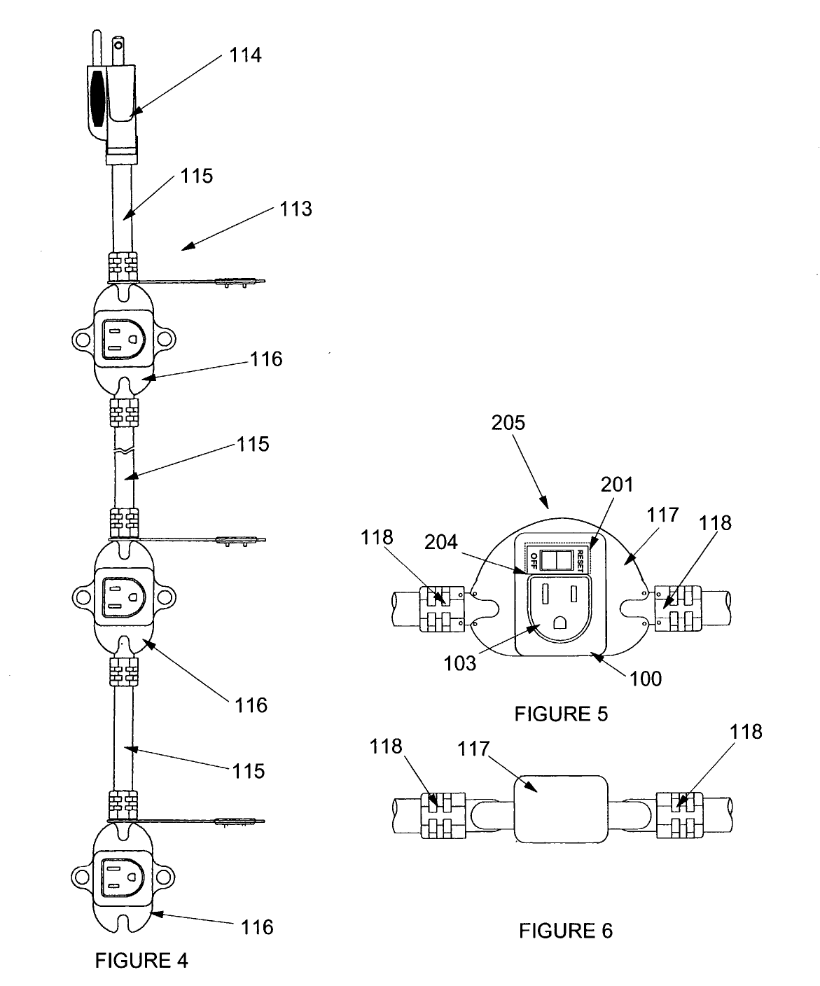

The top views of the piece 100 show that openings 104 and 105 are adapted to receive typical conductive wire prongs of an extension cord plug, a representative plug 114 being shown in FIG. 4 at one end of the fully formed extension cord of the invention. In FIG. 1, opening 106 is adapted to receive a ground wire prong, which prong is also shown in FIG. 4 on plug 114.

FIG. 1 shows that breaker 201 comprises a housing 203 with on-off and reset switch 202, such that internal assemblies in housing 203 accomplish the circuit breaking objects of the invention. Housing 203 is abutted at a long side to a top side of upper housing 101, whereby breaker 201 is operatively connected with piece 101 to prevent overload of a circuit established by connecting an electrical device with the receptacle of piece 100.

FIG. 2 shows that wire engaging ends 112 are formed and adapted to be pressed about a wire end and secure that wire end thereon. Base plate 102 is a substantially flat plate sealingly contacting a bottom edge 131 (FIG. 12) of the upper housing 101. The top of upper housing 101 and the housing 203 of breaker 201 can be seen in FIGS. 2 and 3 to comprise an elevated part at their front surfaces so that when the pre-mold piece 100 and breaker 201 are cast (molded) together into the receptacle body 117 (FIGS. 5 and 6), the flexible body polymer flows around and not into openings 104, 105, and 106 or into the switch 202 openings.

FIG. 1 shows that the receptacle openings 104 and 105 are oriented in a side to side arrangement with respect to wires to be engaged to the wire engaging ends 107-112. The side to side arrangement has not been heretofore used for a single isolated receptacle spaced apart from other such receptacles on a single and unbranched electrical cord. FIG. 2 shows a side view of the upper housing 101 and base plate 102, whereby substantially sealing slots are formed between the top side of the base plate 102 and the lower edge 131 of upper housing 101 to permit passage of the conducting bars 206, 207, 126 and 128 through the housing of the invention pre-mold piece 100. The housing thus secures the conducting bars for external attachment to cord wires (not shown) and to breaker 201, seals the conducting bars against intrusion of molten material used for the receptacle body, laterally supports prong engaging extensions from the conducting bars, and provides openings and guides for plug prongs.

It is a critical function of the pre-mold piece that the conducting bars provide electrical connection from one wire to the next in sequence for the same circuit path substantially along the same axis so that the cord segments can be aligned with an axis that runs roughly perpendicular to the conductive wire prong slots 104 and 105. This particular arrangement is shown in FIG. 4, where receptacles 116, comprising bodies 117 and cord engaging parts 118, intervene between segments 115 of the electrical cord 113. FIGS. 5 and 6 show how a body 117 is formed continuously to parts 118.

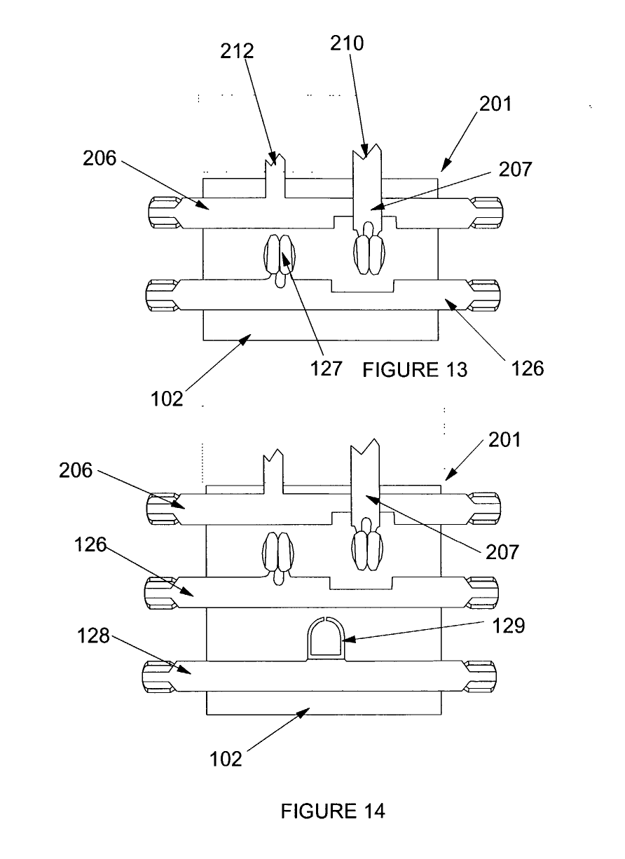

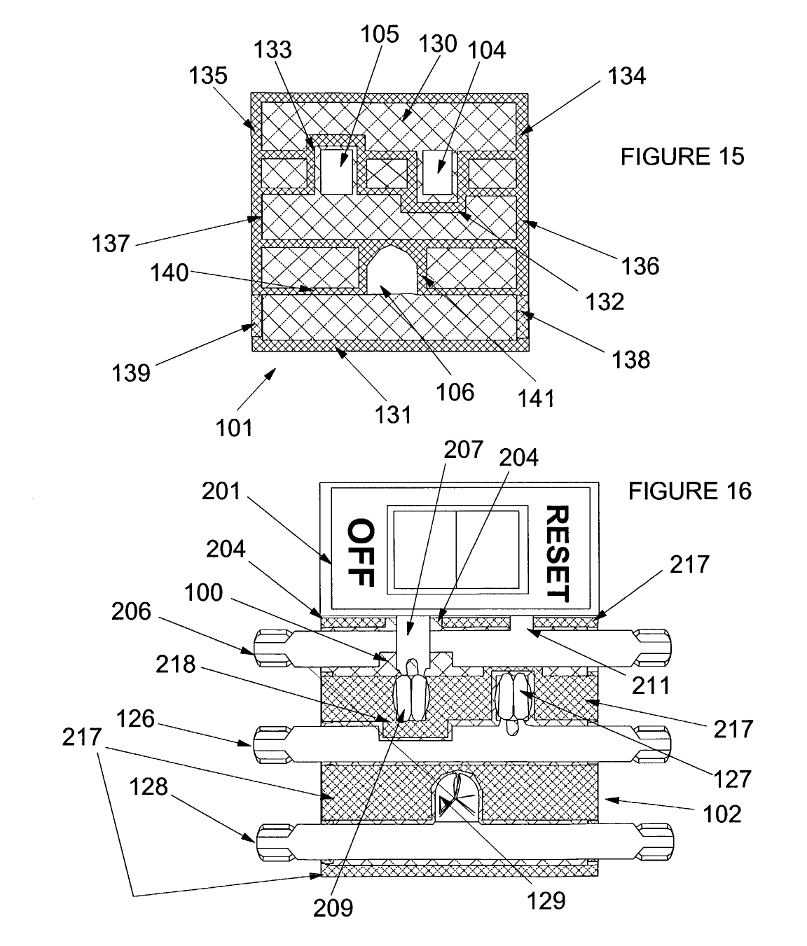

Also critical to the operation of the invention assembly are the structures of the conducting bars 206, 207, 126 and 128 in FIGS. 14 and 15, and more generally shown in FIGS. 7-9 and 10-12. For a middle conductive wire bar, a substantially rigid, preferably copper or aluminum, length 120 comprises two wire engaging ends 122 with cutout 123 and an upward extension 121 adapted with two springingly opposed tabs or other such structures to engage a plug prong. It will be appreciated that the length 120 location of extension 121 and cutout 123 can be exchanged as in piece 126 in FIGS. 13 and 14.

Conducting bars 206 and 207 are unique to operation of the breaker 201. Bar 206 has a base plate 213 that extends to ends 107 and 108 as shown in FIG. 1. Bar 206 comprises an upward extension 212, broken at 213 but understood to continue into and connect operatively with the circuit elements of the breaker 201. Bar 207 comprises an has a base plate 208, broken at 210 but understood to continue into and connect operatively with the circuit elements of the breaker 201, where bar 207 extends to an upward extension 209 adapted with two springingly opposed tabs or other such structures to engage a plug prong. Bars 206 and 207 are oriented in FIGS. 10-12 in the non-contacting manner intended when they are secured in piece 100 and breaker 201. Bar 206 further comprises a cutout 214 adapted to reduce the likelihood of connection between bars 206 and 207. An nonconductive layer may be inserted between bars 206 and 207 to prevent any potential for electrical connection.

FIG. 13 shows the invention orientation with respect to the operative set of bars 206, 207 and 126 to engage plug prongs. The top bars 206 and 207 are adapted to permit upward extension 209 to be associated with the upward extension of middle bar 126 to form a substantially side by side arrangement. Base plate 102 supports the bars in FIGS. 13 and 14. FIG. 14 shows that an additional bar 128 is adapted with a particular semicircular extension for receiving the typical ground wire prong.

FIGS. 15 and 16 show the upper housing 101 adapted to be sealed by adhesive or other means to base plate 102 at its lower edge 131. Lower edge 131 is adapted with slots 134/135, 136/137 and 138/139 so that respectively ends 108/107, 110/109 and 112/111 may emerge beyond the sealing walls of the pre-mold housing. Roof 130 of upper housing 101 represents the underside of the top of upper housing 101 whereby the walls 131-141 extend substantially downward to or just above the top surface of the base plate 102. Walls 132 represent lateral support for extension 209 of bar 207. Walls 133 represent lateral support for extension 127 of bar 126. Walls 141 represent lateral support for extension 129 of bar 128. Wall 140 is representative of the walls that maintain lengthwise orientation of the bars.

FIG. 16 shows that base plate 102 comprises a raised portion 217 above a floor supporting the base plates or blades of bars 206, 126 and 128, where the raised part supports base part 208 at the outside edge of base plate 102 and a bottom side of extension 209 on portion 218 of raised section 217. This arrangement maintains effective separation of bars 206 and 207 so that current must pass through the breaker 201 in order to reach extensions 209 and 121.

FIG. 4 shows that mounting means on the single receptacles 116 permit the user to drive a nail through a loop above the prong openings into a vertical wall to maintain the preferred orientation for the user.

The above design options will sometimes present the skilled designer with considerable and wide ranges from which to choose appropriate apparatus and method modifications for the above examples. However, the objects of the present invention will still be obtained by that skilled designer applying such design options in an appropriate manner.

We claim:

1. A non-branching electrical extension cord with two or more single receptacles located along the length of the extension cord and spaced apart by segments of cord and with a plug on one end of the extension cord comprising:
(a) an assembly of a rigid pre-mold piece and a circuit breaker in a rigid breaker housing adapted to be abutted and integrally joined, where the assembly is substantially covered with a flexible covering material to form a single receptacle;
(b) the pre-mold piece comprising a rigid piece housing sealingly securing therein a mid part of adjacent and parallel top and middle conducting bars, such their ends extend beyond the housing to wire engaging means for conductive wires, two or more plug prong openings are formed in the piece housing aligned substantially perpendicular to and roughly between the axes of the top and middle conducting bars, and an extension from the middle conducting bar forms a prong engaging means beneath one of the prong openings;
(c) an extension from the top conducting bar that extends through the piece housing and breaker housing to connect with an end of the circuit breaker's circuit; and
(d) a breaker conducting bar connected with the other end of the circuit breaker's circuit bar extends through breaker housing and into the piece housing such that its end therein forms an extension forming a prong engaging means beneath the other of one of the prong openings.

2. The cord of claim 1 wherein each of two adjacent conductive wire bars are connected to a circuit portion of segments of conductive wires.

3. The cord of claim 2 wherein tops of the breaker housing and piece housing are substantially in the same plane.

4. The cord of claim 3 wherein a length part of the top conductive bar lies apart from and perpendicular to the breaker conductive bar.

5. The cord of claim 4 wherein an insulating material is located in the space a length between the length part of the top conductive bar and the breaker conductive bar.

6. The cord of claim 1 wherein the cord comprises two or more receptacles separated by cord segments.

7. The cord of claim 1 wherein the cord comprises three or more receptacles separated by cord segments.

8. The cord of claim 1 wherein a body of the receptacles comprises means for hanging the receptacle to a vertical wall.

9. The cord of claim 1 wherein wire engaging means comprise two tabs ex tending from a central part of the ends of each bar.

10. The cord of claim 9 wherein a base plate of the piece housing sealingly attaches to an upper housing, whereby the upper housing defines the prong openings.

11. The cord of claim 1 wherein circuit elements between ends of the breaker conductive bar and the extension of the top conductive bar in the breaker housing define a circuit breaker.
